(19) United States
(12) Patent Application Publication
(10) Pub. No.: US 2025/0358732 A1
(43) Pub. Date: Nov. 20, 2025

(54) INTELLIGENT POWER SAVINGS AND LOW CARBON EMISSION IN CLOUD RAN AND DAS SYSTEMS

(71) Applicant: Outdoor Wireless Networks LLC, Richardson, TX (US)

(72) Inventors: Suresh N. Sriram, Bangalore (IN); Sudarshana Varadappa, Bangalore (IN); Narayana Reddy Korimilla, Bangalore (IN); Yogesh C.S, Bengaluru (IN); Mulayam Kushawaha, Kushinagar (IN); Emil Mathew Kadavil, Bangalore (IN); Satish Kumar Vema, Bangalore (IN); Latha Murugan, Neyveli, Cuddalore (IN); Muralidhar Narayanra Kulkarni, Bangalore Urban (IN)

(73) Assignee: Outdoor Wireless Networks LLC, Richardson, TX (US)

(21) Appl. No.: 18/872,508

(22) PCT Filed: Jun. 2, 2023
(86) PCT No.: PCT/US2023/024368

§ 371 Date: Dec. 6, 2024

Related U.S. Application Data
(60) Provisional application No. 63/476,478, filed on Dec. 21, 2022.

(30) Foreign Application Priority Data
Jun. 7, 2022 (IN) 202241032494

(51) Int. Cl. H04W 52/02; H04B 7/024; H04W 88/08

(52) U.S. Cl. CPC H04W 52/0206; H04B 7/024; H04W 88/085

(57) ABSTRACT

One embodiment is directed to a distributed antenna system serving a base station. The distributed antenna system comprises one or more entities. At least one entity is configured to receive control-plane data from the base station and analyze the control-plane data from the base station on a slot-by-slot basis in order to determine if there is any activity for each slot. At least one entity of the DAS is operated in a low-power mode for a given slot if the corresponding control-plane data for the slot indicate that there is no activity for that slot and is operated in a normal-power mode for a given slot if the corresponding control-plane data for the slot indicate that there is activity for that slot. Other embodiments are disclosed.

### CROSS-REFERENCE TO RELATED APPLICATIONS

This application claims priority to U.S. Provisional Application No. 63/476,478, filed Dec. 21, 2022, and titled “INTELLIGENT POWER SAVINGS AND LOW CARBON EMISSION IN CLOUD RAN AND DAS SYSTEMS,” and also claims priority to IN Provisional Application No. 202241032494, filed Jun. 7, 2022, and titled “INTELLIGENT POWER SAVINGS AND LOW CARBON EMISSION IN CLOUD RAN AND DAS SYSTEMS,” the contents of each of which are hereby incorporated by reference in their entireties.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote units”), where each access point can be coupled directly to one or more of the central access nodes or indirectly via one or more other remote units and/or via one or more intermediary or expansion units or nodes (also referred to here as “transport expansion nodes (TENs)”). A DAS is typically used to improve the coverage provided by one or more base stations that are coupled to the central access nodes. These base stations can be coupled to the one or more central access nodes via one or more cables or via a wireless connection, for example, using one or more donor antennas. The wireless service provided by the base stations can include commercial cellular service and/or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals that are radiated from one or more coverage antennas associated with that access point. The downlink radio frequency signals are radiated for reception by user equipment (UEs). Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits them to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, this involves, among other things, summing uplink signals received from all of the multiple access points in order to produce the base station signal provided to each base station. In this way, the DAS increases the coverage area for the uplink capacity provided by the base stations. An access point may support multiple carriers so that uplink signals can be summed over each of the carriers associated with a base station.

A DAS can use either digital transport, analog transport, or combinations of digital and analog transport for generating and communicating the transport signals between the central access nodes, the access points, and any transport expansion nodes.

Traditionally, a DAS is operated in a “full simulcast” mode in which downlink signals for each base station are transmitted from multiple access points of the DAS and in which uplink signals for each base station are generated by summing uplink data received from all of the multiple access points.

The 3GPP fifth generation (5G) radio access network (RAN) architecture includes a set of base stations (also referred to as “gNBs”) connected to the 5G core network (5GC) and to each other. Each gNB typically comprises three entities—a centralized unit (CU), a distributed unit (DU), and a set of one or more radio units (RUs). The CU can be further split into one or more CU control plane entities (CU-CPs) and one or more CU user plane entities (CU-UPs). The functions of the RAN can be split among these entities in various ways. For example, the functional split between the DU and the RUs can be configured so that the DU implements some of the Layer-1 processing functions (for the wireless interface) and each RU implements the Layer-1 functions that are not implemented in the DU as well as the basic RF and antenna functions. The DU is coupled to each RU using a fronthaul network (for example, one implemented using a switched Ethernet network) over which data is communicated between the DU and each RU including, for example, user-plane data (for example, in-phase and quadrature (IQ) data representing time-domain or frequency-domain symbols). One example of such a configuration is a “Cloud RAN” configuration in which each CU and DU are associated with multiple RUs.

Typically, in a DAS or a Cloud RAN base station, the master unit (in the case of a DAS) or the DU (in the case of a Cloud RAN) manages and serves multiple access points and/or to multiple radio modules of an access point. During low activity times (for example, overnight or when the associated venue is not open to the public or otherwise in use), radios included in the access points and radio units will still perform transmit and receive functions, even though there is no active user recruitment (UE) in the associated cells. Doing this consumes power and, as a result, causes more carbon to be emitted into the environment (due to the generation of the power used to transmit and receive during these inactive periods). This also impacts the operating expenses (OPEX) associated with such systems.

### SUMMARY

The details of one or more embodiments are set forth in the description below. The features illustrated or described in connection with one exemplary embodiment may be combined with the features of other embodiments. Thus, any of the various embodiments described herein can be combined to provide further embodiments. Aspects of the embodiments can be modified, if necessary to employ concepts of the various patents, applications and publications as identified herein to provide yet further embodiments.

In one embodiment, a distributed antenna system serving a base station is disclosed. The distributed antenna system comprises one or more entities, wherein at least one entity is configured to receive control-plane data from the base station and analyze the control-plane data from the base station on a slot-by-slot basis in order to determine if there is any activity for each slot. At least one entity of the distributed antenna system is operated in a low-power mode for a given slot if the corresponding control-plane data for the given slot indicate that there is no activity for that slot and is operated in a normal-power mode for a given slot if the corresponding control-plane data for the slot indicate that there is activity for that slot.

In another embodiment, a base station is disclosed. The base station comprises one or more entities, wherein at least one entity is configured to analyze control-plane data for the base station on a slot-by-slot basis in order to determine if there is any activity for each slot. At least one entity of the base station is operated in a low-power mode for a given slot if the corresponding control-plane data for the given slot indicate that there is no activity for that slot and is operated in a normal-power mode for a given slot if the corresponding control-plane data for the given slot indicate that there is activity for that slot.

In another embodiment, a method for adjusting the operation of a unit of a distributed antenna system is disclosed. The method comprises receiving control-plane data for a given slot of a plurality of slots. The method further comprises determining transmit or receive activity for the unit on the given slot from the control-plane data. Upon determining that the transmit or receive activity for the unit is less than a threshold value, the method comprises setting the unit to a low-power mode for the given slot. Upon determining that the transmit or receive activity for the unit is greater than a threshold value, the method comprises setting the unit to a normal-power mode for the given slot.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, as briefly described below and as further described with reference to the detailed description.

FIGS. 1-4 are block diagrams illustrating exemplary embodiments of a virtualized DAS (vDAS).

FIG. 5 is a block diagram illustrating one exemplary embodiment of a radio access network (RAN) system.

FIGS. 6A-6C are block diagrams illustrating exemplary embodiments of one or more entities of a DAS or base station.

FIG. 7 is a timing diagram illustrating one exemplary embodiment of control-plane and user-plane processing between one or more entities of a DAS or base station.

FIG. 8 is a block diagram illustrating one exemplary embodiment of a method for adjusting the operation of one or more entities of a DAS or base station.

In accordance with common practice, the various described features are drawn to emphasize specific features relevant to the exemplary embodiments. The term “exemplary” merely indicates the accompanying description is used as an example, rather than implying an ideal, essential, or preferable feature of the invention.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

Embodiments of the proposed solution turns-off the transmit and receive processing performed in a CU, DU, and/or RU (or corresponding entities) in a Cloud RAN or other base station and in the master unit, intermediate combining node (ICN), or access points of a DAS on a slot-wise basis without affecting wireless communications with UEs. In doing so, the base station or DAS can operate with reduced costs and power consumption without loss of functionality to the user equipment and only implement full functionality on a dynamic, slot-wise basis.

In some implementations, such transit and/or receive processing is turned off on a slot-wise basis on UE activity. The ORAN Interface defines a Control Plane (C-Plane) and a User Plane (U-Plane). According to one embodiment, an entity of a DAS or base station is configured to analyze the control-plane communications for a given cell served by the DAS or base station. If the control-plane information for a given slot indicates that there is no activity for that slot, the processing that would otherwise be performed for that slot is not performed and at least some of the hardware used to implement one or more entities of the DAS or base station is operated in a low-power (power-saving) state for that slot. If the control-plane information for a given slot indicates that there is activity for that slot (for example, UE-related activity or activity related to the transmission or reception of common signals or random-access channels (RACH) signals).

These techniques can be used in digital DAS. For example, the techniques can be used in the virtualized DAS described below. It is to be understood that these techniques can be used in other types of DASs such as more traditional DASs (for example, non-virtualized DASs).

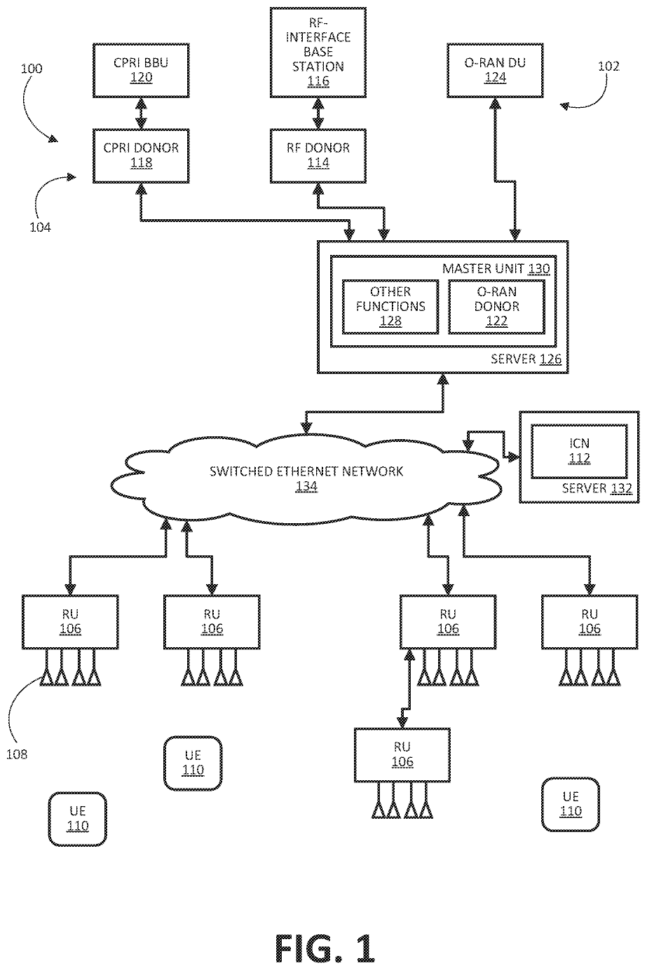

FIG. 1 is a block diagram illustrating an exemplary embodiment of a distributed antenna system (DAS) 100 that is configured to serve one or more base stations 102. In the exemplary embodiment shown in FIG. 1, the DAS 100 includes one or more donor units 104 that are used to couple the DAS 100 to the base stations 102. The DAS 100 also includes a plurality of remotely located radio units (RUs) 106 (also referred to as “antenna units,” “access points,” “remote units,” or “remote antenna units”). The RUs 106 are communicatively coupled to the donor units 104.

Each RU 106 includes, or is otherwise associated with, a respective set of coverage antennas 108 via which downlink analog RF signals can be radiated to user equipment (UEs) 110 and via which uplink analog RF signals transmitted by UEs 110 can be received. The DAS 100 is configured to serve each base station 102 using a respective subset of RUs 106 (which may include less than all of the RUs 106 of the DAS 100). Also, the subsets of RUs 106 used to serve the base stations 102 may differ from base station 102 to base station 102. The subset of RUs points 106 used to serve a given base station 102 is also referred to here as the “simulcast zone” for that base station 102. In general, the wireless coverage of a base station 102 served by the DAS 100 is improved by radiating a set of downlink RF signals for that base station 102 from the coverage antennas 108 associated with the multiple RUs 106 in that base station's stations simulcast zone and by producing a single “combined” set of uplink base station signals or data that is provided to that base station 102. The single combined set of uplink base station signals or data is produced by a combining or summing process that uses inputs derived from the uplink RF signals received via the coverage antennas 108 associated with the RUs 106 in that base station's simulcast zone.

The DAS 100 can also include one or more intermediary combining nodes (ICNs) 112 (also referred to as “expansion” units or nodes). For each base station 102 served by a given ICN 112, the ICN 112 is configured to receive a set of uplink transport data for that base station 102 from a group of “southbound” entities (that is, from RUs 106 and/or other ICNs 112) and generate a single set of combined uplink transport data for that base station 102, which the ICN 112 transmits “northbound” towards the donor unit 104 serving that base station 102. The single set of combined uplink transport data for each served base station 102 is produced by a combining or summing process that uses inputs derived from the uplink RF signals received via the coverage antennas 108 of any southbound RUs 106 included in that base station's simulcast zone. As used here, “southbound” refers to traveling in a direction “away,” or being relatively “farther,” from the donor units 104 and base stations 102, and “northbound” refers to traveling in a direction “towards”, or being relatively “closer” to, the donor units 104 and base stations 102.

In some configurations, each ICN 112 also forwards downlink transport data to the group of southbound RUs 106 and/or ICNs 112 served by that ICN 112. Generally, ICNs 112 can be used to increase the number of RUs 106 that can be served by the donor units 104 while reducing the processing and bandwidth load relative to having the additional RUs 106 communicate directly with each such donor unit 104.

Also, one or more RUs 106 can be configured in a “daisy-chain” or “ring” configuration in which transport data for at least some of those RUs 106 is communicated via at least one other RU 106. Each RU 106 would also perform the combining or summing process for any base station 102 that is served by that RU 106 and one or more of the southbound entities subtended from that RU 106. (Such a RU 106 also forwards northbound all other uplink transport data received from its southbound entities.)

The DAS 100 can include various types of donor units 104. One example of a donor unit 104 is an RF donor unit 114 that is configured to couple the DAS 100 to a base station 116 using the external analog radio frequency (RF) interface of the base station 116 that would otherwise be used to couple the base station 116 to one or more antennas (if the DAS 100 were not being used). This type of base station 116 is also referred to here as an “RF-interface” base station 116. An RF-interface base station 116 can be coupled to a corresponding RF donor unit 114 by coupling each antenna port of the base station 116 to a corresponding port of the RF donor unit 114.

Each RF donor unit 114 serves as an interface between each served RF-interface base station 116 and the rest of the DAS 100 and receives downlink base station signals from, and outputs uplink base station signals to, each served RF-interface base station 116. Each RF donor unit 114 performs at least some of the conversion processing necessary to convert the base station signals to and from the digital fronthaul interface format natively used in the DAS 100 for communicating time-domain baseband data. The downlink and uplink base station signals communicated between the RF-interface base station 116 and the donor unit 114 are analog RF signals. Also, in this example, the digital fronthaul interface format natively used in the DAS 100 for communicating time-domain baseband data can comprise the O-RAN fronthaul interface, a CPRI or enhanced CPRI (eCPRI) digital fronthaul interface format, or a proprietary digital fronthaul interface format (though other digital fronthaul interface formats can also be used).

Another example of a donor unit 104 is a digital donor unit that is configured to communicatively couple the DAS 100 to a baseband entity using a digital baseband fronthaul interface that would otherwise be used to couple the baseband entity to a radio unit (if the DAS 100 were not being used). In the example shown in FIG. 1, two types of digital donor units are shown.

The first type of digital donor unit comprises a digital donor unit 118 that is configured to communicatively couple the DAS 100 to a baseband unit (BBU) 120 using a time-domain baseband fronthaul interface implemented in accordance with a Common Public Radio Interface (“CPRI”) specification. This type of digital donor unit 118 is also referred to here as a “CPRI” donor unit 118, and this type of BBU 120 is also referred to here as a CPRI BBU 120. For each CPRI BBU 120 served by a CPRI donor unit 118, the CPRI donor unit 118 is coupled to the CPRI BBU 120 using the CPRI digital baseband fronthaul interface that would otherwise be used to couple the CPRI BBU 120 to a CPRI remote radio head (RRH) (if the DAS 100 were not being used). A CPRI BBU 120 can be coupled to a corresponding CPRI donor unit 118 via a direct CPRI connection.

Each CPRI donor unit 118 serves as an interface between each served CPRI BBU 120 and the rest of the DAS 100 and receives downlink base station signals from, and outputs uplink base station signals to, each CPRI BBU 120. Each CPRI donor unit 118 performs at least some of the conversion processing necessary to convert the CPRI base station data to and from the digital fronthaul interface format natively used in the DAS 100 for communicating time-domain baseband data. The downlink and uplink base station signals communicated between each CPRI BBU 120 and the CPRI donor unit 118 comprise downlink and uplink fronthaul data generated and formatted in accordance with the CPRI baseband fronthaul interface.

The second type of digital donor unit comprises a digital donor unit 122 that is configured to communicatively couple the DAS 100 to a BBU 124 using a frequency-domain baseband fronthaul interface implemented in accordance with a O-RAN Alliance specification. The acronym “O-RAN” is an abbreviation for “Open Radio Access Network.” This type of digital donor unit 122 is also referred to here as an “O-RAN” donor unit 122, and this type of BBU 124 is typically an O-RAN distributed unit (DU) and is also referred to here as an O-RAN DU 124. For each O-RAN DU 124 served by a O-RAN donor unit 122, the O-RAN donor unit 122 is coupled to the O-DU 124 using the O-RAN digital baseband fronthaul interface that would otherwise be used to couple the O-RAN DU 124 to a O-RAN RU (if the DAS 100 were not being used). An O-RAN DU 124 can be coupled to a corresponding O-RAN donor unit 122 via a switched Ethernet network. Alternatively, an O-RAN DU 124 can be coupled to a corresponding O-RAN donor unit 122 via a direct Ethernet or CPRI connection.

Each O-RAN donor unit 122 serves as an interface between each served O-RAN DU 124 and the rest of the DAS 100 and receives downlink base station signals from, and outputs uplink base station signals to, each O-RAN DU 124. Each O-RAN donor unit 122 performs at least some of any conversion processing necessary to convert the base station signals to and from the digital fronthaul interface format natively used in the DAS 100 for communicating frequency-domain baseband data. The downlink and uplink base station signals communicated between each O-RAN DU 124 and the O-RAN donor unit 122 comprise downlink and uplink fronthaul data generated and formatted in accordance with the O-RAN baseband fronthaul interface, where the user-plane data comprises frequency-domain baseband IQ data. Also, in this example, the digital fronthaul interface format natively used in the DAS 100 for communicating O-RAN fronthaul data is the same O-RAN fronthaul interface used for communicating base station signals between each O-RAN DU 124 and the O-RAN donor unit 122, and the “conversion” performed by each O-RAN donor unit 122 (and/or one or more other entities of the DAS 100) includes performing any needed “multicasting” of the downlink data received from each O-RAN DU 124 to the multiple RUs 106 in a simulcast zone for that O-RAN DU 124 (for example, by communicating the downlink fronthaul data to an appropriate multicast address and/or by copying the downlink fronthaul data for communication over different fronthaul links) and performing any need combining or summing of the uplink data received from the RUs 106 to produce combined uplink data provided to the O-RAN DU 124. It is to be understood that other digital fronthaul interface formats can also be used.

In general, the various base stations 102 are configured to communicate with a core network (not shown) of the associated wireless operator using an appropriate backhaul network (typically, a public wide area network such as the Internet). Also, the various base stations 102 may be from multiple, different wireless operators and/or the various base stations 102 may support multiple, different wireless protocols and/or RF bands.

In general, for each base station 102, the DAS 100 is configured to receive a set of one or more downlink base station signals from the base station 102 (via an appropriate donor unit 104), generate downlink transport data derived from the set of downlink base station signals, and transmit the downlink transport data to the RUs 106 in the base station's simulcast zone. For each base station 102 served by a given RU 106, the RU 106 is configured to receive the downlink transport data transmitted to it via the DAS 100 and use the received downlink transport data to generate one or more downlink analog radio frequency signals that are radiated from one or more coverage antennas 108 associated with that RU 106 for reception by user equipment 110. In this way, the DAS 100 increases the coverage area for the downlink capacity provided by the base stations 102. Also, for any southbound entities (for example, southbound RUs 106 or ICNs 112) coupled to the RU 106 (for example, in a daisy chain or ring architecture), the RU 106 forwards any downlink transport data intended for those southbound entities towards them.

For each base station 102 served by a given RU 106, the RU 106 is configured to receive one or more uplink radio frequency signals transmitted from the user equipment 110. These signals are analog radio frequency signals and are received via the coverage antennas 108 associated with that RU 106. The RU 106 is configured to generate uplink transport data derived from the one or more remote uplink radio frequency signals received for the served base station 102 and transmit the uplink transport data northbound towards the donor unit 104 coupled to that base station 102.

For each base station 102 served by the DAS 100, a single “combined” set of uplink base station signals or data is produced by a combining or summing process that uses inputs derived from the uplink RF signals received via the RUs 106 in that base station's simulcast zone. The resulting final single combined set of uplink base station signals or data is provided to the base station 102. This combining or summing process can be performed in a centralized manner in which the combining or summing process is performed by a single unit of the DAS 100 (for example, a donor unit 104 or master unit 130). This combining or summing process can also be performed in a distributed or hierarchical manner in which the combining or summing process is performed by multiple units of the DAS 100 (for example, a donor unit 104 (or master unit 130) and one or more ICNs 112 and/or RUs 106). Each unit of the DAS 100 that performs the combining or summing process for a given base station 102 receives uplink transport data from that unit's southbound entities and uses that data to generate combined uplink transport data, which the unit transmits northbound towards the base station 102. The generation of the combined uplink transport data involves, among other things, extracting in-phase and quadrature (IQ) data from the received uplink transport data and performing a combining or summing process using any uplink IQ data for that base station 102 in order to produce combined uplink IQ data.

Some of the details regarding how base station signals or data are communicated and transport data is produced vary based on which type of base station 102 is being served. In the case of an RF-interface base station 116, the associated RF donor unit 114 receives analog downlink RF signals from the RF-interface base station 116 and, either alone or in combination with one or more other units of the DAS 100, converts the received analog downlink RF signals to the digital fronthaul interface format natively used in the DAS 100 for communicating time-domain baseband data (for example, by digitizing, digitally down-converting, and filtering the received analog downlink RF signals in order to produce digital baseband IQ data and formatting the resulting digital baseband IQ data into packets) and communicates the resulting packets of downlink transport data to the various RUs 106 in the simulcast zone of that base station 116. The RUs 106 in the simulcast zone for that base station 116 receive the downlink transport data and use it to generate and radiate downlink RF signals as described above. In the uplink, either alone or in combination with one or more other units of the DAS 100, the RF donor unit 114 generates a set of uplink base station signals from uplink transport data received by the RF donor unit 114 (and/or the other units of the DAS 100 involved in this process). The set of uplink base station signals is provided to the served base station 116. The uplink transport data is derived from the uplink RF signals received at the RUs 106 in the simulcast zone of the served base station 116 and communicated in packets.

In the case of a CPRI BBU 120, the associated CPRI digital donor unit 118 receives CPRI downlink fronthaul data from the CPRI BBU 120 and, either alone or in combination with another unit of the DAS 100, converts the received CPRI downlink fronthaul data to the digital fronthaul interface format natively used in the DAS 100 for communicating time-domain baseband data (for example, by re-sampling, synchronizing, combining, separating, gain adjusting, etc. the CPRI baseband IQ data, and formatting the resulting baseband IQ data into packets), and communicates the resulting packets of downlink transport data to the various RUs 106 in the simulcast zone of that CPRI BBU 120. The RUs 106 in the simulcast zone of that CPRI BBU 120 receive the packets of downlink transport data and use them to generate and radiate downlink RF signals as described above. In the uplink, either alone or in combination with one or more other units of the DAS 100, the CPRI donor unit 118 generates uplink base station data from uplink transport data received by the CPRI donor unit 118 (and/or the other units of the DAS 100 involved in this process). The resulting uplink base station data is provided to that CPRI BBU 120. The uplink transport data is derived from the uplink RF signals received at the RUs 106 in the simulcast zone of the CPRI BBU 120.

In the case of an O-RAN DU 124, the associated O-RAN donor unit 122 receives packets of O-RAN downlink fronthaul data (that is, O-RAN user-plane and control-plane messages) from each O-RAN DU 124 coupled to that O-RAN digital donor unit 122 and, either alone or in combination with another unit of the DAS 100, converts (if necessary) the received packets of O-RAN downlink fronthaul data to the digital fronthaul interface format natively used in the DAS 100 for communicating O-RAN baseband data and communicates the resulting packets of downlink transport data to the various RUs 106 in a simulcast zone for that ORAN DU 124. The RUs 106 in the simulcast zone of each O-RAN DU 124 receive the packets of downlink transport data and use them to generate and radiate downlink RF signals as described above. In the uplink, either alone or in combination with one or more other units of the DAS 100, the O-RAN donor unit 122 generates packets of uplink base station data from uplink transport data received by the O-RAN donor unit 122 (and/or the other units of the DAS 100 involved in this process). The resulting packets of uplink base station data are provided to the O-RAN DU 124. The uplink transport data is derived from the uplink RF signals received at the RUs 106 in the simulcast zone of the served O-RAN DU 124 and communicated in packets.

In one implementation, one of the units of the DAS 100 is also used to implement a “master” timing entity for the DAS 100 (for example, such a master timing entity can be implemented as a part of a master unit 130 described below). In another example, a separate, dedicated timing master entity (not shown) is provided within the DAS 100. In either case, the master timing entity synchronizes itself to an external timing master entity (for example, a timing master associated with one or more of the O-DUs 124) and, in turn, that entity serves as a timing master entity for the other units of the DAS 100. A time synchronization protocol (for example, the Institute of Electrical and Electronics Engineers (IEEE) 1588 Precision Time Protocol (PTP), the Network Time Protocol (NTP), or the Synchronous Ethernet (SyncE) protocol) can be used to implement such time synchronization.

A management system (not shown) can be used to manage the various nodes of the DAS 100. In one implementation, the management system communicates with a predetermined “master” entity for the DAS 100 (for example, the master unit 130 described below), which in turns forwards or otherwise communicates with the other units of the DAS 100 for management-plane purposes. In another implementation, the management system communicates with the various units of the DAS 100 directly for management-plane purposes (that is, without using a master entity as a gateway).

Each base station 102 (including each RF-interface base station 116, CPRI BBU 120, and O-RAN DU 124), donor unit 104 (including each RF donor unit 114, CPRI donor unit 118, and O-RAN donor unit 122), RU 106, ICN 112, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.). Such entities can be implemented in other ways.

The DAS 100 can be implemented in a virtualized manner or a non-virtualized manner. When implemented in a virtualized manner, one or more nodes, units, or functions of the DAS 100 are implemented using one or more virtual network functions (VNFs) executing on one or more physical server computers (also referred to here as “physical servers” or just “servers”) (for example, one or more commercial-off-the-shelf (COTS) servers of the type that are deployed in data centers or “clouds” maintained by enterprises, communication service providers, or cloud services providers). More specifically, in the exemplary embodiment shown in FIG. 1, each O-RAN donor unit 122 is implemented as a VNF running on a server 126. The server 126 can execute other VNFs 128 that implement other functions for the DAS 100 (for example, fronthaul, management plane, and synchronization plane functions). The various VNFs executing on the server 126 are also referred to here as “master unit” functions 130 or, collectively, as the “master unit” 130. Also, in the exemplary embodiment shown in FIG. 1, each ICN 112 is implemented as a VNF running on a server 132.

The RF donor units 114 and CPRI donor units 118 can be implemented as cards (for example, Peripheral Component Interconnect (PCI) Cards) that are inserted in the server 126. Alternatively, the RF donor units 114 and CPRI donor units 118 can be implemented as separate devices that are coupled to the server 126 via dedicated Ethernet links or via a switched Ethernet network (for example, the switched Ethernet network 134 described below).

In the exemplary embodiment shown in FIG. 1, the donor units 104, RUs 106 and ICNs 112 are communicatively coupled to one another via a switched Ethernet network 134. Also, in the exemplary embodiment shown in FIG. 1, an O-RAN DU 124 can be coupled to a corresponding O-RAN donor unit 122 via the same switched Ethernet network 134 used for communication within the DAS 100 (though each O-RAN DU 124 can be coupled to a corresponding O-RAN donor unit 122 in other ways). In the exemplary embodiment shown in FIG. 1, the downlink and uplink transport data communicated between the units of the DAS 100 is formatted as O-RAN data that is communicated in Ethernet packets over the switched Ethernet network 134.

In the exemplary embodiment shown in FIG. 1, the RF donor units 114 and CPRI donor units 118 are coupled to the RUs 106 and ICNs 112 via the master unit 130.

In the downlink, the RF donor units 114 and CPRI donor units 118 provide downlink time-domain baseband IQ data to the master unit 130. The master unit 130 generates downlink O-RAN user-plane messages containing downlink baseband IQ that is either the time-domain baseband IQ data provided from the donor units 114 and 118 or is derived therefrom (for example, where the master unit 130 converts the received time-domain baseband IQ data into frequency-domain baseband IQ data). The master unit 130 also generates corresponding downlink O-RAN control-plane messages for those O-RAN user-plane messages. The resulting downlink O-RAN user-plane and control-plane messages are communicated (multicasted) to the RUs 106 in the simulcast zone of the corresponding base station 102 via the switched Ethernet network 134.

In the uplink, for each RF-interface base station 116 and CPRI BBU 120, the master unit 130 receives O-RAN uplink user-plane messages for the base station 116 or CPRI BBU 120 and performs a combining or summing process using the uplink baseband IQ data contained in those messages in order to produce combined uplink baseband IQ data, which is provided to the appropriate RF donor unit 114 or CPRI donor unit 118. The RF donor unit 114 or CPRI donor unit 118 uses the combined uplink baseband IQ data to generate a set of base station signals or CPRI data that is communicated to the corresponding RF-interface base station 116 or CPRI BBU 120. If time-domain baseband IQ data has been converted into frequency-domain baseband IQ data for transport over the DAS 100, the donor unit 114 or 118 also converts the combined uplink frequency-domain IQ data into combined uplink time-domain IQ data as part of generating the set of base station signals or CPRI data that is communicated to the corresponding RF-interface base station 116 or CPRI BBU 120.

In the exemplary embodiment shown in FIG. 1, the master unit 130 (more specifically, the O-RAN donor unit 122) receives downlink O-RAN user-plane and control-plane messages from each served O-RAN DU 124 and communicates (multicasts) them to the RUs 106 in the simulcast zone of the corresponding O-RAN DU 124 via the switched Ethernet network 134. In the uplink, the master unit 130 (more specifically, the O-RAN donor unit 122) receives O-RAN uplink user-plane messages for each served O-RAN DU 124 and performs a combining or summing process using the uplink baseband IQ data contained in those messages in order to produce combined uplink IQ data. The O-RAN donor unit 122 produces O-RAN uplink user-plane messages containing the combined uplink baseband IQ data and communicates those messages to the O-RAN DU 124.

In the exemplary embodiment shown in FIG. 1, only uplink transport data is communicated using the ICNs 112, and downlink transport data is communicated from the master unit 130 to the RUs 106 without being forwarded by, or otherwise communicated using, the ICNs 112.

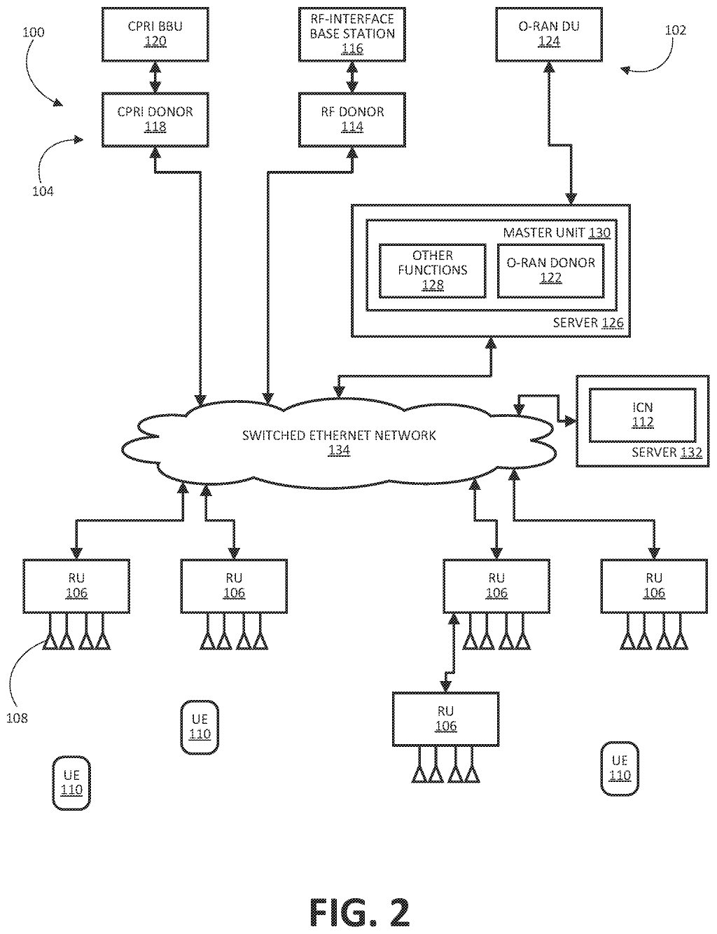

FIG. 2 illustrates another exemplary embodiment of a DAS 100. The DAS 100 shown in FIG. 2 is the same as the DAS 100 shown in FIG. 1 except as described below. In the exemplary embodiment shown in FIG. 2, the RF donor units 114 and CPRI donor units 118 are coupled directly to the switched Ethernet network 134 and not via the master unit 130, as is the case in the embodiment shown in FIG. 1.

As described above, in the exemplary embodiment shown in FIG. 1, the master unit 130 performs some transport functions related to serving the RF-interface base stations 116 and CPRI BBUs 120 coupled to the donor units 114 and 118. In the exemplary embodiment shown in FIG. 2, the RF donor units 114 and CPRI donor units 118 perform those transport functions (that is, the RF donor units 114 and CPRI donor units 118 perform all of the transport functions related to serving the RF-interface base stations 116 and CPRI BBUs 120, respectively).

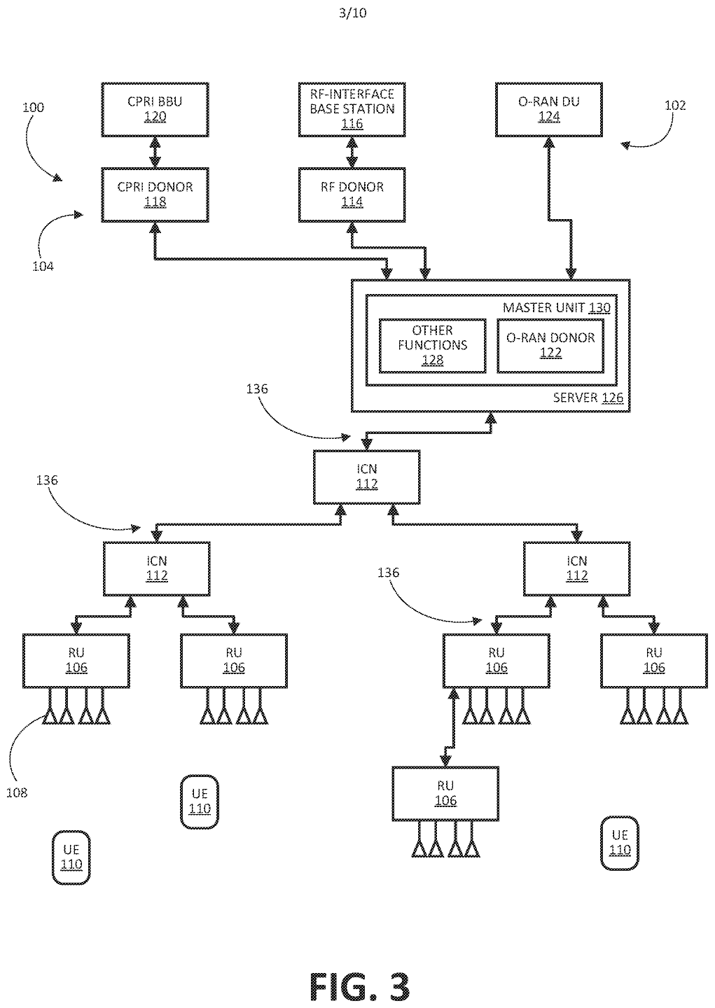

FIG. 3 illustrates another exemplary embodiment of a DAS 100. The DAS 100 shown in FIG. 3 is the same as the DAS 100 shown in FIG. 1 except as described below. In the exemplary embodiment shown in FIG. 3, the donor units 104, RUs 106 and ICNs 112 are communicatively coupled to one another via point-to-point Ethernet links 136 (instead of a switched Ethernet network). Also, in the exemplary embodiment shown in FIG. 3, an O-RAN DU 124 can be coupled to a corresponding O-RAN donor unit 122 via a switched Ethernet network (not shown in FIG. 3), though that switched Ethernet network is not used for communication within the DAS 100. In the exemplary embodiment shown in FIG. 3, the downlink and uplink transport data communicated between the units of the DAS 100 is communicated in Ethernet packets over the point-to-point Ethernet links 136.

For each southbound point-to-point Ethernet link 136 that couples a master unit 130 to an ICN 112, the master unit 130 assembles downlink transport frames and communicates them in downlink Ethernet packets to the ICN 112 over the point-to-point Ethernet link 136. For each point-to-point Ethernet link 136, each downlink transport frame multiplexes together downlink time-domain baseband IQ data and Ethernet data that needs to be communicated to southbound RUs 106 and ICNs 112 that are coupled to the master unit 130 via that point-to-point Ethernet link 136. The downlink time-domain baseband IQ data is sourced from one or more RF donor units 114 and/or CPRI donor units 118. The Ethernet data comprises downlink user-plane and control-plane O-RAN fronthaul data sourced from one or more O-RAN donor units 122 and/or management-plane data sourced from one or more management entities for the DAS 100. That is, this Ethernet data is encapsulated into downlink transport frames that are also used to communicate downlink time-domain baseband IQ data and this Ethernet data is also referred to here as “encapsulated” Ethernet data. The resulting downlink transport frames are communicated in the payload of downlink Ethernet packets communicated from the master unit 130 to the ICN 112 over the point-to-point Ethernet link 136. The Ethernet packets into which the encapsulated Ethernet data is encapsulated are also referred to here as “transport” Ethernet packets.

Each ICN 112 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. Any encapsulated Ethernet data that is intended for the ICN 112 (for example, management-plane Ethernet data) is processed by the ICN 112.

For each southbound point-to-point Ethernet link 136 coupled to the ICN 112, the ICN 112 assembles downlink transport frames and communicates them in downlink Ethernet packets to the southbound entities subtended from the ICN 112 via the point-to-point Ethernet link 136. For each southbound point-to-point Ethernet link 136, each downlink transport frame multiplexes together downlink time-domain baseband IQ data and Ethernet data received at the ICN 112 that needs to be communicated to those subtended southbound entities. The resulting downlink transport frames are communicated in the payload of downlink transport Ethernet packets communicated from the ICN 112 to those subtended southbound entities ICN 112 over the point-to-point Ethernet link 136.

Each RU 106 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. As described above, the RU 106 uses any downlink time-domain baseband IQ data and/or downlink O-RAN user-plane and control-plane fronthaul messages to generate downlink RF signals for radiation from the set of coverage antennas 108 associated with that RU 106. The RU 106 processes any management-plane messages communicated to that RU 106 via encapsulated Ethernet data.

Also, for any southbound point-to-point Ethernet link 136 coupled to the RU 106, the RU 106 assembles downlink transport frames and communicates them in downlink Ethernet packets to the southbound entities subtended from the RU 106 via the point-to-point Ethernet link 136. For each southbound point-to-point Ethernet link 136, each downlink transport frame multiplexes together downlink time-domain baseband IQ data and Ethernet data received at the RU 106 that needs to be communicated to those subtended southbound entities. The resulting downlink transport frames are communicated in the payload of downlink transport Ethernet packets communicated from the RU 106 to those subtended southbound entities ICN 112 over the point-to-point Ethernet link 136.

In the uplink, each RU 106 generates uplink time-domain baseband IQ data and/or uplink O-RAN user-plane fronthaul messages for each RF-interface base station 116, CPRI BBU 120, and/or O-RAN DU 124 served by that RU 106 as described above. For each northbound point-to-point Ethernet link 136 of the RU 106, the RU 106 assembles uplink transport frames and communicates them in uplink transport Ethernet packets northbound towards the appropriate master unit 130 via that point-to-point Ethernet link 136. For each northbound point-to-point Ethernet link 136, each uplink transport frame multiplexes together uplink time-domain baseband IQ data originating from that RU 106 and/or any southbound entity subtended from that RU 106 as well as any Ethernet data originating from that RU 106 and/or any southbound entity subtended from that RU 106. In connection with doing this, the RU 106 performs the combining or summing process described above for any base station 102 served by that RU 106 and also by one or more of the subtended entities. (The RU 106 forwards northbound all other uplink data received from those southbound entities.) The resulting uplink transport frames are communicated in the payload of uplink transport Ethernet packets northbound towards the master unit 130 via the associated point-to-point Ethernet link 136.

Each ICN 112 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. For each northbound point-to-point Ethernet link 136 coupled to the ICN 112, the ICN 112 assembles uplink transport frames and communicates them in uplink transport Ethernet packets northbound towards the master unit 130 via that point-to-point Ethernet link 136. For each northbound point-to-point Ethernet link 136, each uplink transport frame multiplexes together uplink time-domain baseband IQ data and Ethernet data received at the ICN 112 that needs to be communicated northbound towards the master unit 130. The resulting uplink transport frames are communicated in the payload of uplink transport Ethernet packets communicated northbound towards the master unit 130 over the point-to-point Ethernet link 136.

Each master unit 130 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. Any extracted uplink time-domain baseband IQ data, as well as any uplink O-RAN messages communicated in encapsulated Ethernet, is used in producing a single “combined” set of uplink base station signals or data for the associated base station 102 as described above (which includes performing the combining or summing process). Any other encapsulated Ethernet data (for example, management-plane Ethernet data) is forwarded on towards the respective destination (for example, a management entity).

In the exemplary embodiment shown in FIG. 3, synchronization-plane messages are communicated using native Ethernet packets (that is, non-encapsulated Ethernet packets) that are interleaved between the transport Ethernet packets.

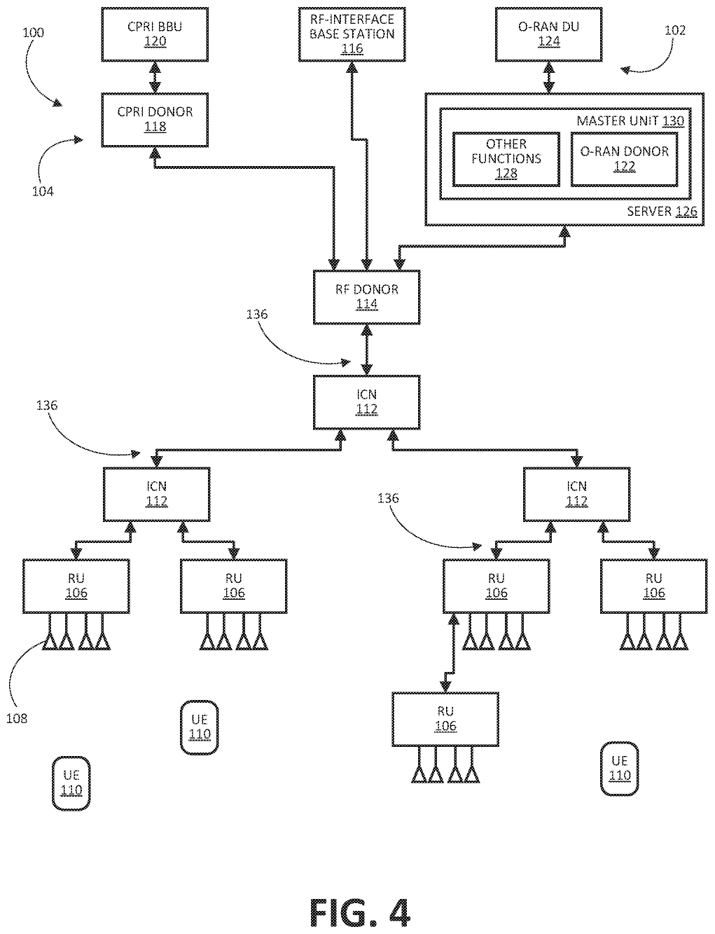

FIG. 4 illustrates another exemplary embodiment of a DAS 100. The DAS 100 shown in FIG. 4 is the same as the DAS 100 shown in FIG. 3 except as described below. In the exemplary embodiment shown in FIG. 4, the CPRI donor units 118, O-RAN donor unit 122, and master unit 130 are coupled to the RUs 106 and ICNs 112 via one or more RF units 114. That is, each RF unit 114 performs the transport frame multiplexing and demultiplexing that is described above in connection with FIG. 3 as being performed by the master unit 130.

The power saving techniques described above can also be implemented in a base station such as one described below.

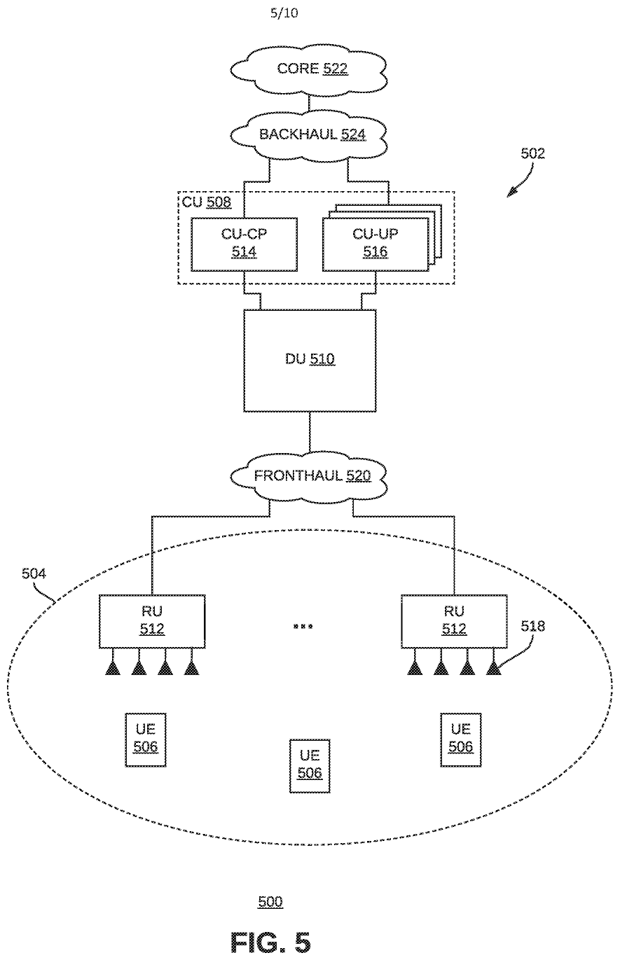

FIG. 5 is a block diagram illustrating one exemplary embodiment of a radio access network (RAN) system 500 in which the slot-by-slot power saving techniques described above can be used.

The system 500 shown in FIG. 5 implements at least one base station entity 502 to serve a cell 504. Each such base station entity 502 can also be referred to here as a “base station” or “base station system” (and, which in the context of a fourth generation (4G) Long Term Evolution (LTE) system, may also be referred to as an “evolved NodeB”, “eNodeB”, or “eNB” and, in the context of a fifth generation (5G) New Radio (NR) system, may also be referred to as a “gNodeB” or “gNB”).

In general, each base station 502 is configured to provide wireless service to various items of user equipment (UEs) 506 served by the associated cell 504. Unless explicitly stated to the contrary, references to Layer 1, Layer 2, Layer 3, and other or equivalent layers (such as the Physical Layer or the Media Access Control (MAC) Layer) refer to layers of the particular wireless interface (for example, 4G LTE or 5G NR) used for wirelessly communicating with UEs 506. Furthermore, it is also to be understood that 5G NR embodiments can be used in both standalone and non-standalone modes (or other modes developed in the future) and the following description is not intended to be limited to any particular mode. Moreover, although some embodiments are described here as being implemented for use with 5G NR, other embodiments can be implemented for use with other wireless interfaces and the following description is not intended to be limited to any particular wireless interface.

In the specific exemplary embodiment shown in FIG. 5, each base station 502 is implemented as a respective 5G NR gNB 502 (only one of which is shown in FIG. 5 for ease of illustration). In this embodiment, each gNB 502 is partitioned into one or more central unit entities (CUs) 508, one or more distributed unit entities (DUs) 510, and one or more radio units (RUs) 512. In such a configuration, each CU 508 implements Layer 3 and non-time critical Layer 2 functions for the gNB 502. In the embodiment shown in FIG. 5, each CU 508 is further partitioned into one or more control-plane entities 514 and one or more user-plane entities 516 that handle the control-plane and user-plane processing of the CU 508, respectively. Each such control-plane CU entity 514 is also referred to as a “CU-CP” 514, and each such user-plane CU entity 516 is also referred to as a “CU-UP” 516. Also, in such a configuration, each DU 510 is configured to implement the time critical Layer 2 functions and, except as described below, at least some of the Layer 1 functions for the gNB 502. In this example, each RU 512 is configured to implement the physical layer functions for the gNB 502 that are not implemented in the DU 510 as well as the RF interface. Also, each RU 512 includes or is coupled to a respective set of one or more antennas 518 via which downlink RF signals are radiated to UEs 506 and via which uplink RF signals transmitted by UEs 506 are received.

In one implementation (shown in FIG. 5), each RU 512 is remotely located from each DU 510 serving it. Also, in such an implementation, at least one of the RUs 512 is remotely located from at least one other RU 512 serving the associated cell 504. In another implementation, at least some of the RUs 512 are co-located with each other, where the respective sets of antennas 518 associated with the RUs 512 are directed to transmit and receive signals from different areas. Moreover, in the implementation shown in FIG. 5, the gNB 502 includes multiple RUs 512 to serve a single cell 504; however, it is to be understood that gNB 502 can include only a single RU 512 to serve a cell 504.

Each RU 512 is communicatively coupled to the DU 510 serving it via a fronthaul network 520. The fronthaul network 520 can be implemented using a switched Ethernet network, in which case each RU 512 and each physical node on which each DU 510 is implemented includes one or more Ethernet network interfaces to couple each RU 512 and each DU physical node to the fronthaul network 520 in order to facilitate communications between the DU 510 and the RUs 512. In one implementation, the fronthaul interface promulgated by the O-RAN Alliance is used for communication between the DU 510 and the RUs 512 over the fronthaul network 520. In another implementation, a proprietary fronthaul interface that uses a so-called “functional split 7-2” for at least some of the physical channels (for example, for the PDSCH and PUSCH) and a different functional split for at least some of the other physical channels (for example, using a functional split 6 for the PRACH and SRS).

In such an example, each CU 508 is configured to communicate with a core network 522 of the associated wireless operator using an appropriate backhaul network 524 (typically, a public wide area network such as the Internet).

Although FIG. 5 (and the description set forth below more generally) is described in the context of a 5G embodiment in which each logical base station entity 502 is partitioned into a CU 508, DUs 510, and RUs 512 and, for at least some of the physical channels, some physical-layer processing is performed in the DUs 510 with the remaining physical-layer processing being performed in the RUs 512, it is to be understood that the techniques described here can be used with other wireless interfaces (for example, 4G LTE) and with other ways of implementing a base station entity (for example, using a conventional baseband band unit (BBU)/remote radio head (RRH) architecture). Accordingly, references to a CU, DU, or RU in this description and associated figures can also be considered to refer more generally to any entity (including, for example, any “base station” or “RAN” entity) implementing any of the functions or features described here as being implemented by a CU, DU, or RU.

Each CU 508, DU 510, and RU 512, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.).

Moreover, each CU 508, DU 510, and RU 512, can be implemented as a physical network function (PNF) (for example, using dedicated physical programmable devices and other circuitry) and/or a virtual network function (VNF) (for example, using one or more general purpose servers (possibly with hardware acceleration) in a scalable cloud environment and in different locations within an operator's network (for example, in the operator's “edge cloud” or “central cloud”). Each VNF can be implemented using hardware virtualization, operating system virtualization (also referred to as containerization), and application virtualization as well as various combinations of two or more the preceding. Where containerization is used to implement a VNF, it may also be referred to as a “containerized network function” (CNF).

For example, in the exemplary embodiment shown in FIG. 5, each RU 512 is implemented as a PNF and is deployed in or near a physical location where radio coverage is to be provided and each CU 508 and DU 510 is implemented using a respective set of one or more VNFs deployed in a distributed manner within one or more clouds (for example, within an “edge” cloud or “central” cloud).

Each CU 508, DU 510, and RU 512, and any of the specific features described here as being implemented thereby, can be implemented in other ways.

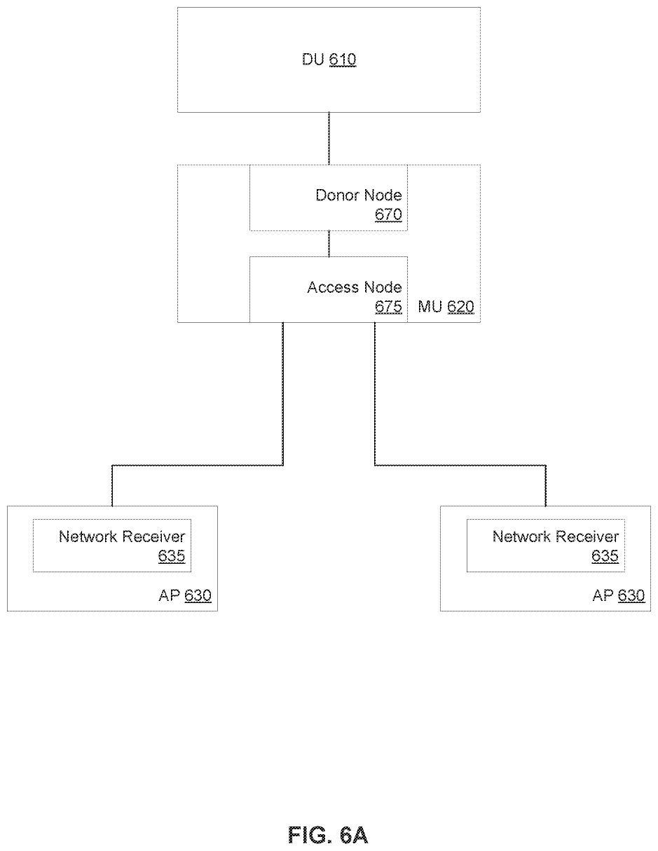

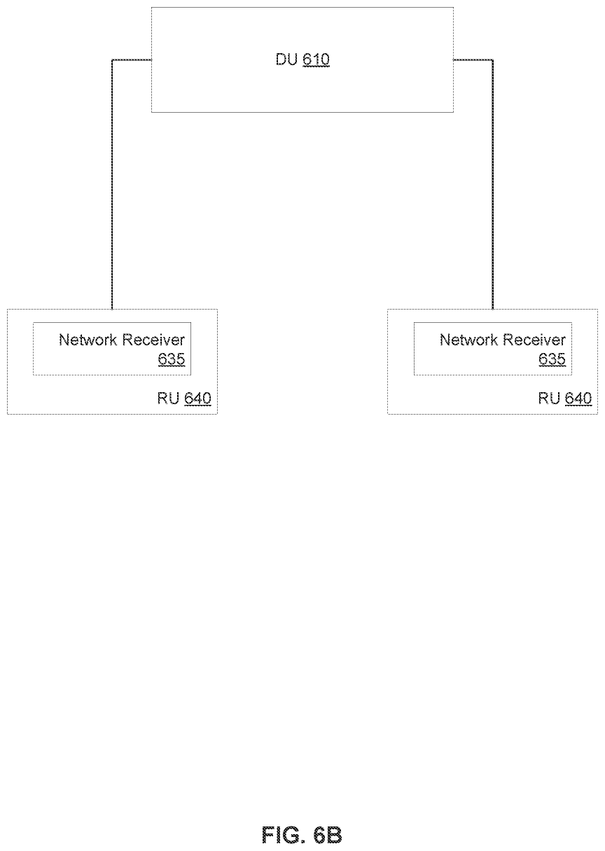

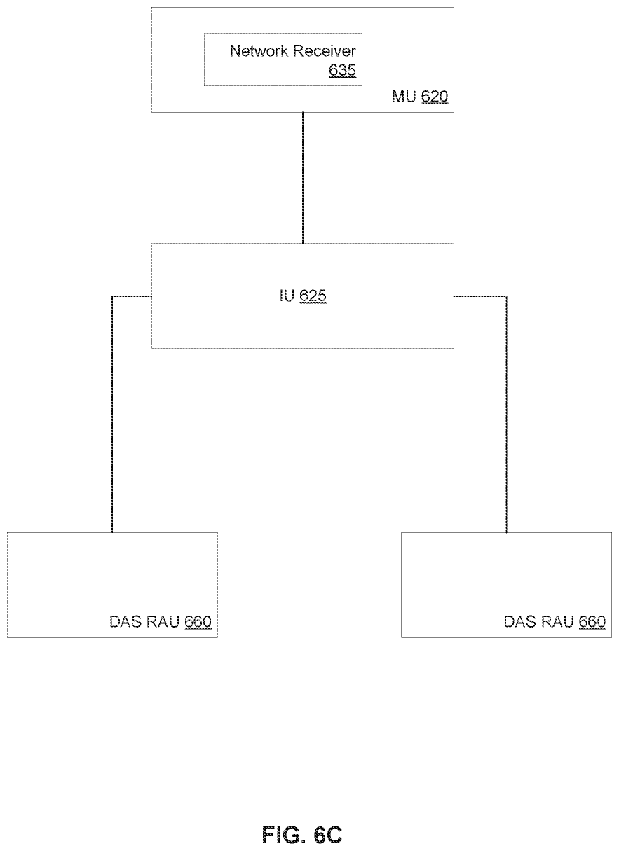

FIGS. 6A-6C are block diagrams illustrating exemplary embodiments of one or more entities of a DAS or base station, which may include the entities described in conjunction with FIGS. 1-5. FIG. 6A depicts one embodiment of a DAS architecture similar to the vDAS systems described in FIGS. 1-C. FIG. 6B depicts an exemplary base station architecture comprising a DU 610 communicatively coupled to one or more RUs 640 distributed in one or more coverage zones. FIG. 6C depicts one example of a physical DAS architecture. In FIGS. 6A-6B, the distributed unit (DU) 610 can be implemented as the DU 510 of FIG. 5, the master unit (MU) 620 (comprising the donor node 670 and access node 675) can be implemented as the vMU 130 of FIGS. 1-4, and access points (AP) 630 or RU 640 can be implemented as the RU 106 or RU 512 of FIGS. 1-5. However, at least in the implementation shown in FIG. 6C, the MU 620 and DAS remote antenna units (RAUs) 660 can be implemented as conventional analog or digital nodes in the DAS. Additionally, the DAS RAUs 660 can be communicatively coupled to the MU 620 through an intermediate unit (IU) 625, which can be implemented as a conventional intermediate unit or via the ICN 112 of FIGS. 1-4. Although not explicitly shown in FIGS. 6A-6C, the DAS or base station can include any number of DU 610, MU 620, AP 630, RU 640, or DAS RAU 660. The architectures illustrated in FIGS. 6A-6C are non-exhaustive and non-exclusive and can be combined depending on the implementation.

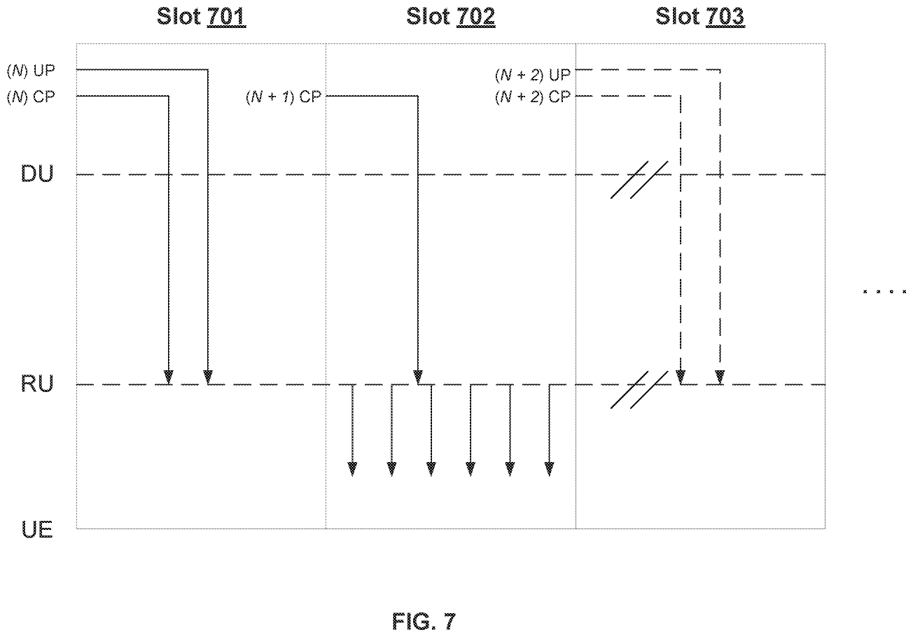

FIG. 7 is a timing diagram illustrating one exemplary embodiment of control-plane and user-plane processing in a DAS or base station. The exemplary system used to describe the processing associated with the control-plane and user-plane data includes a DU and at least one RU understanding that other entities can be used as well, including but not limited to, an MU or ICN as previously described. The at least one RU described in the context of FIG. 7 can be associated with a simulcast zone, as previously described.

The control-plane (CP) and user-plane (UP) data communicated from the base station entity to one or more entities of the base station or DAS corresponds to a particular slot of processing activity associated with the one or more entities. Each slot corresponds to a designated processing time interval synchronized between the DU and the at least one RU. For pedagogical explanation, the timing of the slots is associated with slot 701 corresponding to the earliest slot and slot 703 corresponding to the latest slot, with slot 702 processed in between slots 701 and slot 703. Additionally, the slots 701—slot 703 are described as being performed successively for pedagogical explanation.

As an example, the control-plane data for slot 702 (slot N) will be communicated during the preceding slot 701 (slot N−1) to the DU and additionally to the RUs in the simulcast zone. In this example, the control-plane data for slot 701 indicates that there will be activity during slot 702 (for example, there will downlink transmissions to UEs on the physical downlink shared channel (PDSCH) during slot N). As shown in slot 701, the user-plane data corresponding to these transmissions to UEs for slot 702 is also communicated during slot 701. As a result, the associated entities of the DAS or base station are operated in the “normal” (non-power-saving) mode for slot 702. In FIG. 7, the at least one RU is configured to transmit downlink communication signals carrying the user-plane data in slot 701 to the UEs while operating in the normal mode.

Still referring to FIG. 7, the control-plane data for slot 703 (slot N+1) will be communicated during the preceding slot 702 (slot N). In this example, the control-plane data for slot 702 indicates that there will be no activity during slot 703. Accordingly, no user-plane data corresponding to any downlink signal transmissions is communicated to the DU and RU for slot 702. As a result, the associated entities of the DAS or base station are operated in the “low power” (power-saving) mode for slot 703 during which time they do not process or transmit downlink signals to UEs in accordance with the control-plane data received during slot 702. The process of receiving control-plane and optionally user-plane data for subsequent slots, for example, the immediately succeeding slot N+2 (slot 703), can be repeated for any number of slots needed to process network signals between the entities and user equipment.

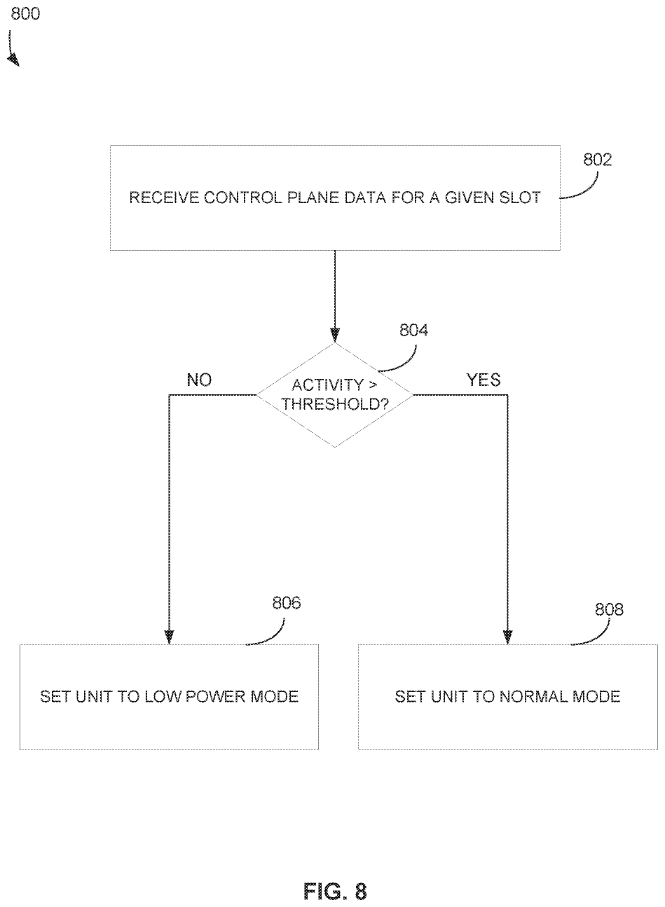

This can be done for both uplink and downlink transmissions, as described in conjunction with FIG. 8. Note that for uplink transmissions, the control-plane communications are still communicated in the downlink direction (even though the corresponding user-plane data is communicated in the uplink direction).

For Common Control Messages like synchronization signal block (SSB) Transmission, system information block (SIB) Transmission, and other types of non-UE activity transmissions, the associated entities (or portions thereof) will continue to be operated in the normal mode (that is, “turned-ON”) for the downlink irrespective of whether there is UE activity in the downlink (DL) direction. That is, such common control messages or other common transmissions are in themselves activity of the entities of the base station or DAS but do not impact downlink transmission of user-plane data to UEs. For uplink transmission, the associated entities (or portions thereof) will be operated in the normal mode (that is, “turned-ON”) for non-UE activity communications such as common messages, signals, and channels like physical random access channels (PRACH) and sounding reference signals (SRS) opportunities but will remain in the low-power mode for slots in which the control-plane data generated for the particular slot indicates there is no UE activity during the slot. Instead, the associated entities will operate in the normal mode for uplink transmission when the control-plane data generated for uplink reception is present in the previous slot.

In this way, the downlink RF transmission path and uplink reception path (and associated entities or portions) will be in “normal” or active mode with respect to these paths only during active communication with UEs (during downlink RF transmission) or base station entities (during uplink RF reception) and will be operating in a low-power mode (by not communicating over the downlink RF or uplink RF paths) during slots of no downlink RF activity or uplink RF activity.

A similar process can be applied for activity between the base station entities and the MU or other front end units in the DAS. A MU such as the vMU 130 or MU 620 generally includes two nodes: a donor node 670 and an access node 675. The donor node 670 interfaces between the input of the MU and a corresponding donor node of the base station entities communicatively coupled to the MU (not shown in FIGS. 6A-6C). In contrast, the access node 675 is implemented further downstream of the donor node 670 and interfaces between the output of the MU 620 and signal pathways of the downstream entities of the DAS, such as IU 625 or RU 640. In this implementation, the MU donor node 670 will receive base station control-plane data for a given slot and determine from the base station control-plane data whether there will be any activity for the given slot at the MU. If there is activity detected from the base station control-plane data, the MU 620 will operate in a normal power mode for the access node 675 processors in which activity was detected. Conversely, if no activity is detected from the base station control-plane data, the access node 675 processors for the MU 620 will enter into a low-power mode for the duration of the given slot. As previously described, some operations of the MU 620 (namely portions of the MU 620 that operate independently of control-plane data) may remain active even when the access node 675 processors are powered down or turned off in the low-power mode.

By powering off entities during periods when the DAS or base station entities are communicating with UEs or vice-versa, the DAS or base station can be implemented with less power throughout than a conventional DAS or base station that operates active at all time periods. Such power-saving techniques effectively reduce the costs of implementing the DAS or base station and improve power efficiency in the DAS, all without impacting service to the UEs in the coverage area.

Also, it should be understood that the power-saving methods described herein can also be used in a DAS that is coupled to at least one base station using either an RF analog interface or a CPRI (or similar interface). In these situations, a receiver or other processing device can be implemented in an entity within the DAS (for example, within a master unit or donor unit) that is configured to perform receiver processing of the type performed in a UE (see network receiver 635 in FIGS. 6A-6C). This is done in order to decode or otherwise recover (e.g., for a remote unit) or generate (e.g., for a master unit) the control-plane (control channel) information in the downlink. This control-plane information is then used as described above in order to determine when to switch between a normal mode of operation and a low-power mode of operation. Also, for the downlink, it is possible to analyze the power levels of the time-domain IQ data for the downlink order to determine if there is any activity in the downlink to determine when to switch between a normal mode of operation and a low-power mode of operation.

FIG. 8 is a block diagram illustrating one exemplary embodiment of a method 800 for adjusting the power of one or more entities of a DAS or base station. The blocks of the flow diagram shown in FIG. 8 have been arranged in a generally sequential manner for ease of explanation; however, it is to be understood that this arrangement is merely exemplary, and it should be recognized that the processing associated with method 800 and the blocks shown in FIG. 8 can occur in a different order, for example, where at least some of the processing associated with the blocks is performed in parallel and/or in an event-drive manner. Also, most standard exception handling is not described for ease of explanation; however, it is to be understood that method 800 can and typically would include such exception handling.

In some implementations, method 800 is performed for downlink signal activity from one or more entities of a DAS or base station as shown and described in conjunction with FIGS. 6-7. In other implementations, method 800 is performed for uplink signal activity from user equipment, as described further below.

Method 800 includes receiving control-plane data from at least one entity at block 802. In some implementations where downlink signal activity is monitored, the control-plane data is received from one or more entities of a base station, such as a 5G eNb/gNb base station or one or more components thereof, such as a distributed unit (DU) as shown and described in conjunction with FIGS. 5-6. Additionally, the one or more entities can include one or more entities of a distributed antenna system communicatively coupled to a base station, including a master unit, intermediate unit(s), and one or more DAS remote antenna units.

When the at least one entity is an entity of the base station, which will be pedagogically described as a remote unit (e.g., a remote radio head, radio point, access point, etc.), the remote unit is configured to determine, at block 804, whether there is downlink transmit activity from the received control-plane data. The activity is determined on a per-slot basis. If there is any activity for a given slot, method 800 proceeds to block 808 and sets the remote unit to operate in a normal-power mode for the given slot. In one implementation, method determines whether there is activity by determining whether the communications signal carrying the control-plane data exceeds a threshold level. In normal-mode operation, the remote unit is configured to transmit downlink signals over-the-air to user equipment based on the control-plane and user-plane communications data. However, if there no activity detected from the control-plane data (e.g., the signals carrying control-plane communications data are less than the threshold), then method 800 proceeds to block 806 by setting the remote unit to a low-power mode for the given slot. While operating in the low-power mode, the remote unit is not configured to transmit downlink signals over-the-air to user equipment. In some implementations, while operating in the low-power mode the remote unit is configured to transmit common control messages such as synchronization signal block (SSB) messaging, system information block (SIB) messaging, or other messaging protocols. By powering down the remote unit during periods of no downlink signal activity, the remote unit can be implemented with reduced costs without disrupting user equipment activity in the network.

In some implementations, method 800 can be performed for one or more entities of a distributed antenna system, such as a master unit or intermediate unit communicatively coupled downstream of the master unit. In one exemplary implementation, the master unit includes a donor plane communicatively coupled to a donor plane of the base station and an access plane communicatively coupled to other units downstream in the distributed antenna system (see FIG. 6A). The donor plane of the master unit is configured to receive the control-plane data corresponding to a given slot at block 802. Once the control-plane data is received, the donor plane is configured to determine whether there is activity present in the control-plane data for the given slot. For example, the donor plane can determine whether the communications signal carrying the control-plane data exceeds a threshold level (block 804). If activity exceeding the threshold is determined at block 804, then method 800 proceeds by setting the master unit to operate in a normal-power mode at block 808. In this mode, the master unit is configured to transmit downlink transport signals carrying the control-plane and user-plane data for the given slot to the DAS remote unit(s) associated with the master unit, where ultimately the user-plane communications data is communicated to the user equipment. However, if there is no activity for the given slot exceeding the threshold value at block 804, then method 800 proceeds by setting the access plane of the master unit to operate in a low-power mode. In the low-power mode, the master unit does not communicate downlink transport signals to the intermediate units and/or DAS remote units downstream of the master unit for the given slot. In some implementations, one or more additional units downstream of the master unit can operate in a low-power mode along with the master unit for the given slot in which no activity was detected. For example, referring to FIG. 6C, upon determining that no activity is present for a given slot, the master unit 620 enters a low-power mode during the given slot and is configured to direct the intermediate unit 625 and DAS remote unit 640 to operate in a low-power mode. Doing so further reduces the power consumption in the DAS during time intervals in which the base station is not communicating user-plane data to user equipment in the downlink direction.

Referring back to FIG. 8, in some implementations method 800 is performed based on activity corresponding to uplink signal communication from user equipment to one or more base station entities. Similarly to the downlink operation, method 800 can be performed in the uplink direction for one or more entities of a base station or one or more entities of a distributed antenna system. For pedagogical explanation, method 800 will be described in the uplink direction in the context of a remote unit understanding that such description is merely exemplary and that other entities are also applicable.

At block 802, method 800 receives control-plane communications data at the remote unit from user equipment. In some implementations, the remote unit includes a network receiver 635 configured to receive uplink signals, and to recover control-plane data from the user equipment. The remote unit can detect when the user equipment will undergo transmit activity in the uplink direction for a given slot based on the control-plane data. For example, at block 804, the remote unit determines whether there is any activity for the given slot by determining whether the signal power corresponding to the control-plane data exceeds a threshold value.

If the signal power corresponding to the control-plane data exceeds the threshold at block 804, then method 800 proceeds to block 808 and sets the remote unit to a normal-power mode for the given slot. In the normal-power mode, the remote unit is configured to communicate the uplink user-plane data corresponding to the activity for the given slot to one or more entities of the base station, such as the distributed unit 610. However, if the signal power corresponding to the control-plane data does not exceed the threshold at block 804, then method 800 proceeds to block 806 and sets the remote unit to a low-power mode for the given slot. In the low-power mode, the remote unit does not communicate uplink signals to the distributed unit or other base station entities communicatively coupled upstream of the remote unit. Instead, the remote unit powers down for the duration of the given slot, thereby reducing power consumption and costs. In some implementations, the remote unit is configured to communicate other messages that are independent of UE-related activity for the given slot. For example, the remote unit is configured to transmit physical random access channel (PRACH) messages to the distributed unit while operating in the low-power mode.

The methods and techniques described herein may be implemented in digital electronic circuitry, or with a programmable processor (for example, a special-purpose processor or a general-purpose processor such as a computer) firmware, software, or in various combinations of each. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instruction to, a data storage system, at least one input device, and at least one output device. Generally, a processor will receive instructions and data from a read-only memory and/or a random-access memory. Storage devices suitable for tangibly embodying computer program instructions and data include all forma of non-volatile memory, including by way of example semiconductor memory devices, such as erasable programmable read-only memory (EPROM), electrically erasable programmable read-only memory (EEPROM), and flash memory devices; magnetic disks such as internal hard disks and removable disks; magneto-optical disks; and digital video disks (DVDs). Any of the foregoing may be supplemented by, or incorporated in, specially-designed application specific integrated circuits (ASICs).

### EXAMPLE EMBODIMENTS

Example 1 includes a distributed antenna system (DAS) serving a base station, the distributed antenna system comprising: one or more entities, wherein at least one entity is configured to receive control-plane data from the base station and analyze the control-plane data from the base station on a slot-by-slot basis in order to determine if there is any activity for each slot; wherein at least one entity of the DAS is operated in a low-power mode for a given slot if a corresponding control-plane data for the given slot indicate that there is no activity for the given slot and is operated in a normal-power mode for the given slot if the corresponding control-plane data for the given slot indicate that there is activity for the given slot.

Example 2 includes the distributed antenna system of Example 1, wherein the distributed antenna system is configured to receive time-domain data from the base station and wherein at least one entity in the distributed antenna system is configured to perform receiver processing on the time-domain data in order to recover or generate the control-plane data.

Example 3 includes the distributed antenna system of Example 2, wherein the distributed antenna system is configured to receive the time-domain data from the base station using at least one of an analog radio frequency (RF) interface and a common public radio interface (CPRI).

Example 4 includes the distributed antenna system of any of Examples 1-3, wherein the at least one entity is configured to determine, based on the control-plane data, activity for a subsequent slot of a plurality of slots, and wherein the at least one entity is configured to operate in a low-power mode for the subsequent slot.

Example 5 includes the distributed antenna system of Example 4, wherein the at least one entity is configured to analyze the control-plane data to determine if there is any activity for another slot subsequent to the subsequent slot while the at least one entity is operating in the low-power mode.

Example 6 includes the distributed antenna system of any of Examples 1-5, wherein the at least one entity comprises at least one of: a distributed unit (DU), a master unit (MU), and a remote unit (RU).

Example 7 includes the distributed antenna system of Example 6, wherein the MU comprises a donor node and an access node, wherein the donor node is configured to determine whether the control-plane data from the base station indicate activity for a subsequent slot of a plurality of slots, wherein the access node is configured to operate in a low-power mode when the control-plane data indicate there is activity for the subsequent slot.

Example 8 includes the distributed antenna system of any of Examples 1-7, wherein the at least one entity is configured to transmit common control messages while operating in the low-power mode.

Example 9 includes the distributed antenna system of any of Examples 1-8, wherein the at least one entity is configured to transmit physical random access channel (PRACH) messages while operating in the low-power mode.

Example 10 includes a base station comprising: one or more entities, wherein at least one entity is configured to analyze control-plane data for the base station on a slot-by-slot basis in order to determine if there is any activity for each slot; wherein at least one entity of the base station is operated in a low-power mode for a given slot if a corresponding control-plane data for the given slot indicate that there is no activity for the given slot and is operated in a normal-power mode for the given slot if the corresponding control-plane data for the given slot indicate that there is activity for the given slot.

Example 11 includes the base station of Example 10, wherein the at least one entity is configured to determine, based on the control-plane data, activity for a subsequent slot of a plurality of slots, and wherein the at least one entity is configured to operate in a low-power mode for the subsequent slot.

Example 12 includes the base station of Example 11, wherein the at least one entity is configured to analyze the control-plane data to determine if there is any activity for another slot subsequent to the subsequent slot while the at least one entity is operating in the low-power mode.

Example 13 includes the base station of any of Examples 11-12, wherein the at least one entity comprises at least one of: a distributed unit (DU) and a remote unit (RU).

Example 14 includes the base station of any of Examples 11-13, wherein the base station is communicatively coupled to a distributed antenna system, wherein the at least one entity is configured to provide the control-plane data to at least one unit of the distributed antenna system.

Example 15 includes a method for adjusting operation of a unit of a distributed antenna system, comprising: receiving control-plane data for a given slot of a plurality of slots; determining transmit or receive activity for the unit on the given slot from the control-plane data; upon determining that the transmit or receive activity for the unit is less than a threshold value, setting the unit to a low-power mode for the given slot; and upon determining that the transmit or receive activity for the unit is greater than a threshold value, setting the unit to a normal-power mode for the given slot.

Example 16 includes the method of Example 15, comprising: determining, based on the control-plane data, activity for a subsequent slot of the plurality of slots, and setting the unit in a low-power mode for the subsequent slot.

Example 17 includes the method of Example 16, comprising: analyzing the control-plane data to determine if there is any activity for another slot subsequent to the subsequent slot while operating in the low-power mode.

Example 18 includes the method of any of Examples 15-17, comprising: receiving time-domain data from a base station; and performing receiver processing on the time-domain data in order to recover or generate the control-plane data.

Example 19 includes the method of any of Examples 15-18, comprising: transmitting common control messages while operating in the low-power mode.

Example 20 includes the method of any of Examples 15-19, comprising: transmitting physical random access channel (PRACH) messages while operating in the low-power mode.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A distributed antenna system (DAS) serving a base station, the distributed antenna system comprising:
one or more entities, wherein at least one entity is configured to receive control-plane data from the base station and analyze the control-plane data from the base station on a slot-by-slot basis in order to determine if there is any activity for each slot;
wherein at least one entity of the DAS is operated in a low-power mode for a given slot if a corresponding control-plane data for the given slot indicate that there is no activity for the given slot and is operated in a normal-power mode for the given slot if the corresponding control-plane data for the given slot indicate that there is activity for the given slot.

2. The distributed antenna system of claim 1, wherein the distributed antenna system is configured to receive time-domain data from the base station and wherein at least one entity in the distributed antenna system is configured to perform receiver processing on the time-domain data in order to recover or generate the control-plane data.

3. The distributed antenna system of claim 2, wherein the distributed antenna system is configured to receive the time-domain data from the base station using at least one of an analog radio frequency (RF) interface and a common public radio interface (CPRI).

4. The distributed antenna system of claim 1, wherein the at least one entity is configured to determine, based on the control-plane data, activity for a subsequent slot of a plurality of slots, and wherein the at least one entity is configured to operate in a low-power mode for the subsequent slot.

5. The distributed antenna system of claim 4, wherein the at least one entity is configured to analyze the control-plane data to determine if there is any activity for another slot subsequent to the subsequent slot while the at least one entity is operating in the low-power mode.

6. The distributed antenna system of claim 1, wherein the at least one entity comprises at least one of: a distributed unit (DU), a master unit (MU), and a remote unit (RU).

7. The distributed antenna system of claim 6, wherein the MU comprises a donor node and an access node, wherein the donor node is configured to determine whether the control-plane data from the base station indicate activity for a subsequent slot of a plurality of slots, wherein the access node is configured to operate in a low-power mode when the control-plane data indicate there is activity for the subsequent slot.

8. The distributed antenna system of claim 1, wherein the at least one entity is configured to transmit common control messages while operating in the low-power mode.

9. The distributed antenna system of claim 1, wherein the at least one entity is configured to transmit physical random access channel (PRACH) messages while operating in the low-power mode.

10. A base station comprising:
one or more entities, wherein at least one entity is configured to analyze control-plane data for the base station on a slot-by-slot basis in order to determine if there is any activity for each slot;
wherein at least one entity of the base station is operated in a low-power mode for a given slot if a corresponding control-plane data for the given slot indicate that there is no activity for the given slot and is operated in a normal-power mode for the given slot if the corresponding control-plane data for the given slot indicate that there is activity for the given slot.

11. The base station of claim 10, wherein the at least one entity is configured to determine, based on the control-plane data, activity for a subsequent slot of a plurality of slots, and wherein the at least one entity is configured to operate in a low-power mode for the subsequent slot.

12. The base station of claim 11, wherein the at least one entity is configured to analyze the control-plane data to determine if there is any activity for another slot subsequent to the subsequent slot while the at least one entity is operating in the low-power mode.

13. The base station of claim 11, wherein the at least one entity comprises at least one of: a distributed unit (DU) and a remote unit (RU).

14. The base station of claim 11, wherein the base station is communicatively coupled to a distributed antenna system, wherein the at least one entity is configured to provide the control-plane data to at least one unit of the distributed antenna system.

15. A method for adjusting operation of a unit of a distributed antenna system, comprising:
receiving control-plane data for a given slot of a plurality of slots;
determining transmit or receive activity for the unit on the given slot from the control-plane data;
upon determining that the transmit or receive activity for the unit is less than a threshold value, setting the unit to a low-power mode for the given slot; and
upon determining that the transmit or receive activity for the unit is greater than a threshold value, setting the unit to a normal-power mode for the given slot.

16. The method of claim 15, comprising:
determining, based on the control-plane data, activity for a subsequent slot of the plurality of slots, and
setting the unit in a low-power mode for the subsequent slot.

17. The method of claim 16, comprising:
analyzing the control-plane data to determine if there is any activity for another slot subsequent to the subsequent slot while operating in the low-power mode.

18. The method of claim 15, comprising:
receiving time-domain data from a base station; and
performing receiver processing on the time-domain data in order to recover or generate the control-plane data.

19. The method of claim 15, comprising:
transmitting common control messages while operating in the low-power mode.

20. The method of claim 15, comprising:
transmitting physical random access channel (PRACH) messages while operating in the low-power mode.
